(19) United States
(12) Patent Application Publication
(10) Pub. No.: US 2014/0344730 A1
(43) Pub. Date: Nov. 20, 2014

(54) METHOD AND APPARATUS FOR REPRODUCING CONTENT

(71) Applicant: SAMSUNG ELECTRONICS CO., LTD., Suwon-si (KR)

(72) Inventor: Akazawa YOSHIAKI, Yokohama-si (JP)

(73) Assignee: SAMSUNG ELECTRONICS CO., LTD., Suwon-si (KR)

(21) Appl. No.: 14/278,169

(22) Filed: May 15, 2014

(30) Foreign Application Priority Data
May 15, 2013 (JP) 2013-102977
Jan. 29, 2014 (KR) 10-2014-0011730

(51) Int. Cl. G06F 3/0484

(52) U.S. Cl. CPC G06F 3/0484
USPC 715/764

(57) ABSTRACT

A content reproduction apparatus displays a timeline on a limited screen display area so that a user may easily understand and manipulate content. The content reproduction apparatus includes a content receiver configured to receive content, a content display configured to display the content, a tag location recorder configured to record respective locations of tags on time axes, wherein the tags indicate boundaries of area of the content, a timeline estimator configured to estimate a timeline that shows time axes of the content and expand and reduce the time axes of the timeline for each area of the content based on respective importance values of the areas of the content and the location information of the tags recorded in the tag location recorder, and a timeline display configured to display the timeline.

### CROSS REFERENCE TO RELATED APPLICATIONS

This application claims priority from Korean Patent Application No. 10-2014-0011730, filed on Jan. 29, 2014, in the Korean Intellectual Property Office, and Japanese Patent Application No. 2013-102977, filed on May 15, 2013, in the Japanese Patent Office, the disclosures of which are incorporated herein by reference in their entireties.

### BACKGROUND

1. Field

Apparatuses and methods consistent with exemplary embodiments relate to an apparatus for reproducing content, and more particularly, to a method and apparatus for reproducing content, whereby a timeline showing time axes of content is displayed.

2. Description of the Related Art

In order to provide one form of control over content reproduction, a function providing time-sequential control of an entire flow (i.e., a timeline) of content has been developed. Such a function may be implemented by arranging respective still images from certain time points of the content, as shown in FIG. 14, or as a simple slider bar as shown in FIG. 15.

Further, in other related art, a “face section” concept may be used in conjunction with a timeline such that respective face images (thumbnail images of faces) of characters appearing in some content is displayed in each face section. Thus, this arrangement may make it possible to find a scene in which a certain character appears in the content (for example, refer to JP 2010-054948 (published on 11 Mar. 2010)).

Because a timeline is uniformly divided into a plurality of time intervals, the timeline may not be fully displayed on a screen of a small terminal device due to its limited screen size, or a user may have to press a button-type remote control for digital TVs many times to move along the timeline.

### SUMMARY

According to an aspect of an exemplary embodiment, there is provided a method of reproducing content, the method including receiving a manipulation input from a user that provides information relating to reproducing content displayed on a screen, receiving an importance value of the content based on history of the manipulation input, recording location information of tags on a time axis, wherein the tags indicate boundaries within the content, generating a timeline based on the importance value of the content and the location information of the tags, and displaying the timeline.

The generating of the timeline may further include estimating respective importance values of areas of the content based on the history of the manipulation input that is received with respect to each area of the content.

The generating of the timeline may further include expanding and reducing the time axis of the timeline based on respective importance values of areas of the content and the location information of the tags.

The generating of the timeline may further include using respective importance values of areas of same type content received in the past as the respective importance values of the areas of the content.

The generating of the timeline may further include estimating respective importance values of areas of the content such that a longer time area has a higher importance value.

The respective locations of the tags on the time axis may be boundaries of areas of the content, the areas being chapters or scenes.

The generating of the timeline may further include estimating respective importance values of areas of the content such that an area that has a greater amount of motion has a higher importance value.

According to an aspect of an exemplary embodiment, there is provided an apparatus for reproducing content, the apparatus including a content receiver configured to receive content, a content display configured to display the content, a tag location recorder configured to record respective locations of tags on time axes, wherein the tags indicate boundaries of area of the content, a timeline estimator configured to estimate a timeline that shows time axes of the content and expand and reduce the time axes of the timeline for each area of the content based on respective importance values of the areas of the content and the location information of the tags recorded in the tag location recorder, and a timeline display configured to display the timeline.

The apparatus may further include a content manipulator configured to acquire a manipulation input from a user, based on information related to reproducing the content displayed on the content display, and a content manipulation history recorder configured to record history of the manipulation input, wherein the timeline estimator is further configured to estimate the respective importance values of the areas of the content based on history of the manipulation input that is recorded in the content manipulation history recorder with respect to each area of the content.

The timeline estimator may be further configured to use respective importance values of areas of same type content received in the past as the respective importance values of the areas of the content.

The timeline estimator may be further configured to estimate the respective importance values of the areas of the content such that a longer time area has a higher importance value.

The timeline estimator may be further configured to estimate the respective importance values of the areas of the content such that an area that has a greater amount of motion has a higher importance value.

A non-transitory computer-readable recording medium having recorded thereon a program, which, when executed by a computer, may performs the method.

Additional aspects will be set forth in part in the description which follows and, in part, will be apparent from the description, or may be learned by practice of the presented embodiments.

### BRIEF DESCRIPTION OF THE DRAWINGS

These and/or other aspects will become apparent and more readily appreciated from the following description of the exemplary embodiments, taken in conjunction with the accompanying drawings in which:

FIG. 1 is a block diagram of a content reproduction apparatus according to an exemplary embodiment;

FIG. 2 is a block diagram of a modified example of the content reproduction apparatus according to an exemplary embodiment;

FIG. 3 i illustrates tags being applied to content and areas being divided according to the tags according to an exemplary embodiment;

FIG. 4 illustrates respective manipulation histories of different areas of the content and allocating importance values to the areas of the content according to an exemplary embodiment;

FIG. 5 illustrates compressing and normalizing sizes of display areas based on the respective importance values of the areas according to an exemplary embodiment;

FIG. 6 is a view of a timeline, according to an exemplary embodiment;

FIG. 7 is another view of a timeline, according to another exemplary embodiment;

FIG. 8 is a view comparing a conventional timeline and operations of moving the conventional timeline with a timeline and operations of moving the timeline according to an exemplary embodiment;

FIG. 9 illustrates applying respective importance values of areas of a watched program to a non-watched program of the same type according to an exemplary embodiment;

FIG. 10 illustrates comparing programs of the same type that have slightly different content according to an exemplary embodiment;

FIG. 11 is a score matrix of letter correspondence penalties between two same type programs according to an exemplary embodiment;

FIG. 12 is a score matrix of letter movement penalties between two same type programs according to an exemplary embodiment;

FIG. 13 illustrates analogizing and thus applying the respective importance values of the areas of the watched program to the non-watched program of the same type according to an exemplary embodiment;

FIG. 14 is an exemplary view of a timeline;

FIG. 15 is another exemplary view of another timeline; and

FIG. 16 is a flowchart of a content reproduction method according to an exemplary embodiment.

### DETAILED DESCRIPTION

Reference will now be made in detail to exemplary embodiments, examples of which are illustrated in the accompanying drawings, wherein like reference numerals refer to like elements throughout. In this regard, the present exemplary embodiments may have different forms and should not be construed as being limited to the descriptions set forth herein. Accordingly, the exemplary embodiments are merely described below, by referring to the figures, to explain aspects of the present description.

While such terms as “first,” “second,” etc., may be used to describe various components, such components must not be limited to the above terms. The above terms are used only to distinguish one component from another.

The terms used in the present specification are merely used to describe particular exemplary embodiments, and are not intended to be limiting. The terms in the exemplary embodiments are selected as general terms used currently as widely as possible regarding functions of elements in the exemplary embodiments. However, in specific cases, terms arbitrarily selected by the applicant are also used, and in such cases, the meanings are mentioned in the corresponding detailed description section, so one or more exemplary embodiments should be understood not by literal meanings of the terms but by given meanings of the terms.

An expression used in the singular encompasses the expression of the plural, unless it has a clearly different meaning in the context. In the present specification, it is to be understood that the terms such as “including”, “having,” and “comprising” are intended to indicate the existence of the features, numbers, steps, actions, components, parts, or combinations thereof disclosed in the specification, and are not intended to preclude the possibility that one or more other features, numbers, steps, actions, components, parts, or combinations thereof may exist or may be added.

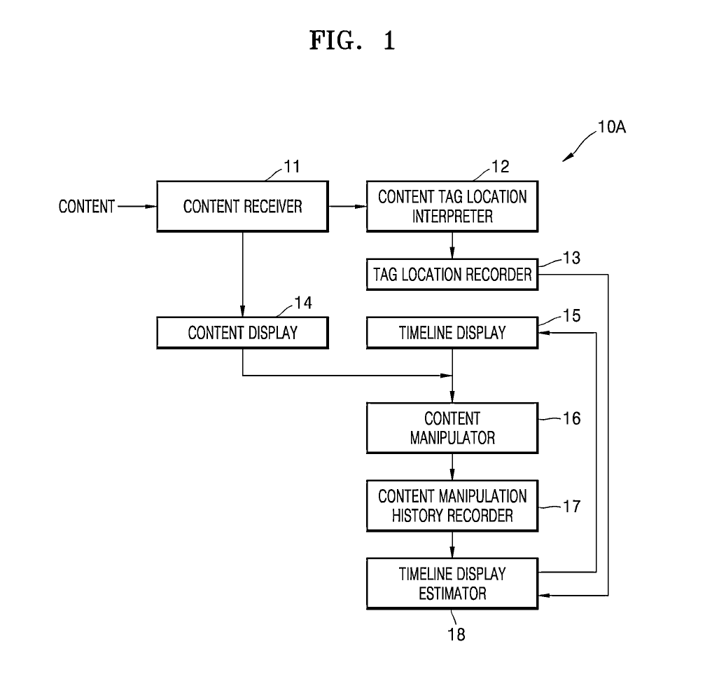

FIG. 1 is a block diagram of a content reproduction apparatus 10A according to an exemplary embodiment. The content reproduction apparatus 10A according to the present exemplary embodiment includes a content receiver 11, a content tag location interpreter 12, a tag location recorder 13, a content display 14, a timeline display 15, a content manipulator 16, a content manipulation history recorder 17, and a timeline estimator 18.

The content reproduction apparatus 10A receives and reproduces TV or radio content transmitted from a content distribution company. Examples of the content reproduction apparatus 10A may include a TV, a mobile phone, a personal computer, a tablet device, and the like. Examples of a content distribution method may include a terrestrial distribution method, a satellite distribution method, or an Internet distribution method.

The content reproduction apparatus 10A receives content via the content receiver 11. For example, the content receiver 11 may be a tuner in the case of the terrestrial distribution method or a network adapter or a mobile device in the case of the Internet distribution method. The received content is displayed on the content display 14 and watched by a user.

The content tag location interpreter 12 estimates respective tag locations of the received content. The tag location recorder 13 records estimated tag location information. Tags will be described in detail below.

The timeline estimator 18 estimates a timeline to be displayed based on recorded tag location information. The timeline display 15 displays the estimated timeline.

The content display 14 and the timeline display 15 may be provided on the same screen. Alternatively, the timeline display 15 may be displayed on another screen.

The user manipulates the content by using the content manipulator 16 based on information displayed on the content display 14 and the timeline display 15. The content manipulation history recorder 17 records manipulation history of the content.

The timeline estimator 18 estimates displayed content of the timeline based on the manipulation history of the content and the recorded tag location information acquired from the tag location recorder 13. The displayed content of the timeline are re-estimated each time when content is updated in the content manipulation history recorder 17.

Tag information of the content may be acquired by being estimated in the content reproduction apparatus 10A, but the acquiring method is not limited thereto. For example, a tag information distribution company may write tag information for the content, and then, the tag location recorder 13 may record the tag information of the content.

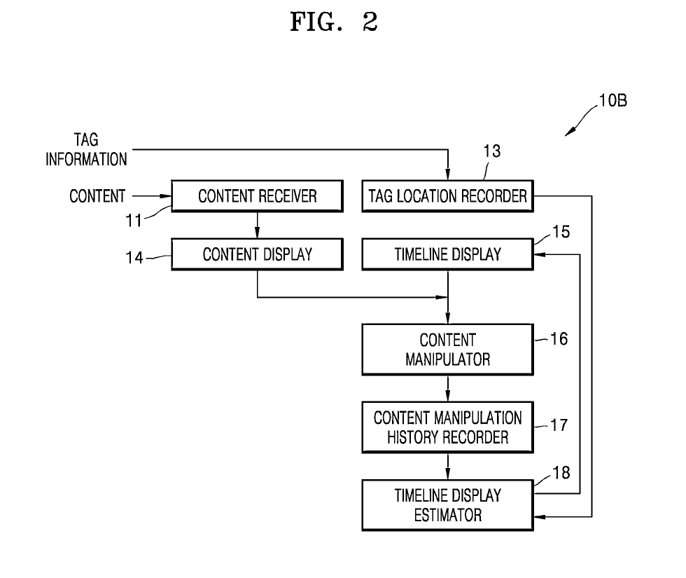

Alternatively, the user may write and individually apply the tag information. In this case, the content tag location interpreter 12 may be removed from the content reproduction apparatus 10A, and thus form a content reproduction apparatus 10B as shown in FIG. 2.

Currently, meta tags, which indicate divided portions of content referred to as chapter tags, are applied to most distributed content. Also, a device may automatically apply meta tags to and divide chapters of content to which chapter tags are not applied.

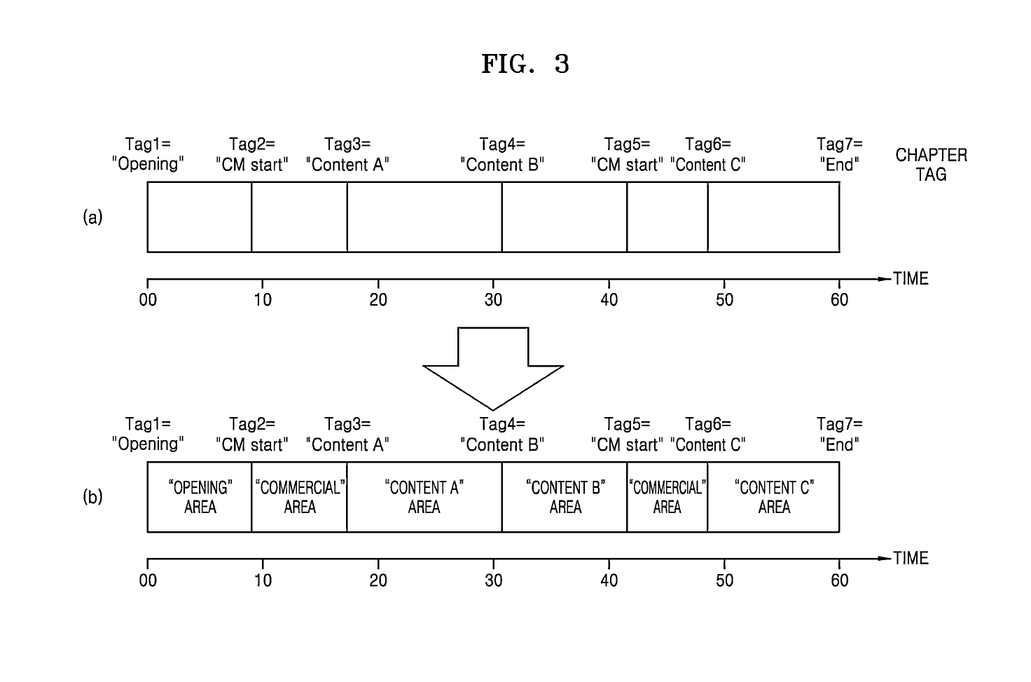

FIG. 3 is a view illustrating tags being applied to content and areas being divided according to the tags. The term “areas” indicate elements of content at predetermined time intervals, such as chapters or scenes. For example, content having chapter tags as in FIG. 3(a) may be divided into areas as in FIG. 3(b).

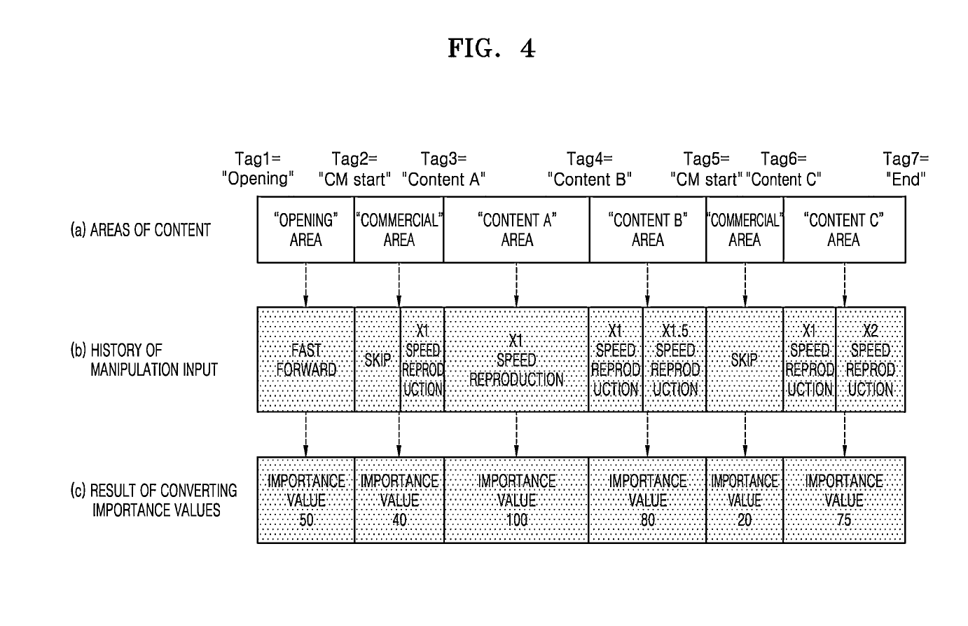

FIG. 4 is a view illustrating respective manipulation histories of areas of the content and allocating importance values to the areas of the content. Manipulation results, which are obtained when the user manipulates the content that is divided into areas as shown in (a) of FIG. 4, may be allocated to each area as shown in (b) of FIG. 4. Table 1 shows importance values that respectively correspond to the respective manipulation histories of the areas. Based on Table 1, the importance values are allocated to each area as in (c) of FIG. 4.

TABLE 1

| Content Manipulation | Importance (Imp) |
|---|---|
| Reproduction | 100 |
| x1.5 speed reproduction | 70 |
| x2 speed reproduction | 60 |
| Fast Forward | 50 |
| Not manipulated | 40 |
| Skip | 20 |
| • | • |
| • | • |
| • | • |

The importance values are empirical values that may be determined based on statistical data of evaluation values regarding the timeline according to the present exemplary embodiment, in which the evaluation values are obtained from a plurality of subjects.

The importance values may be average importance values of n-number of manipulations in some areas, and are defined by Equation 1.

$$\begin{matrix}[ Equation 1 ] & \\ {aveimp}_{i} = \frac{{\sum }_{j = 0}^{{n}_{i}} imp ( {index}_{i} ( j ) ) {t}_{ij}}{{\sum }_{j = 0}^{{n}_{i}} {t}_{ij}} & ( 1 )\end{matrix}$$

where “i” is i-th area of the content, “aveimpᵢ” is an average importance in the i-th area, indexᵢ(j) is a manipulation time in the i-th area, nᵢ is a total number of manipulations in the i-th area, and tᵢⱼ is a manipulation time of j-th manipulation in the i-th area.

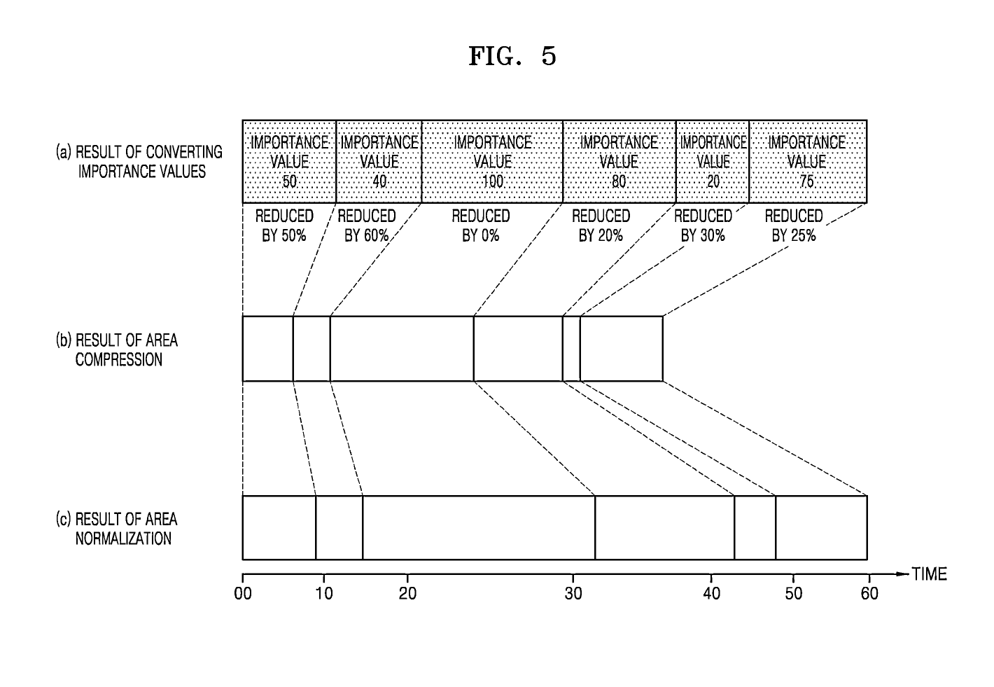

FIG. 5 is a view illustrating compressing and normalizing sizes of display areas based on the respective importance values of the areas according to an exemplary embodiment. FIG. 5 illustrates an example of a result obtained by estimating the respective importance values of the areas by using Equation 1. New display sizes of the areas are estimated by using Equation 2, according to the respective importance values.

[Equation 2]

newsizeᵢ=oldsize_{is*(}100−aveimpᵢ)/100 (2)

where “newsizeᵢ” is a new display size of the i-th area, and “oldsizeᵢ” is a current display size of the i-th area.

As shown in (a) of FIG. 5, respective importance values are allocated for the areas of the content, respective new display sizes of the areas are estimated by using Equation 2, and then, the display areas are compressed as shown in (b) of FIG. 5. The areas expand as in (c) of FIG. 5 such that each of the areas correspond the original screen size while maintaining a relative ratio from the results of compression. Therefore, the timeline may be displayed according to the respective importance values of the areas of the content.

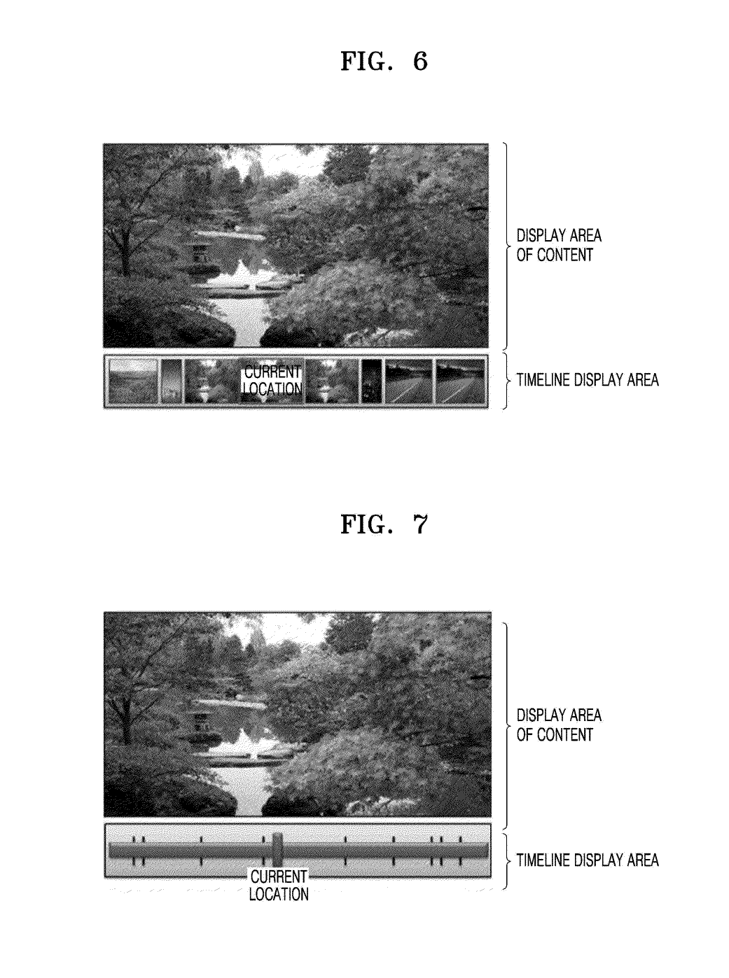

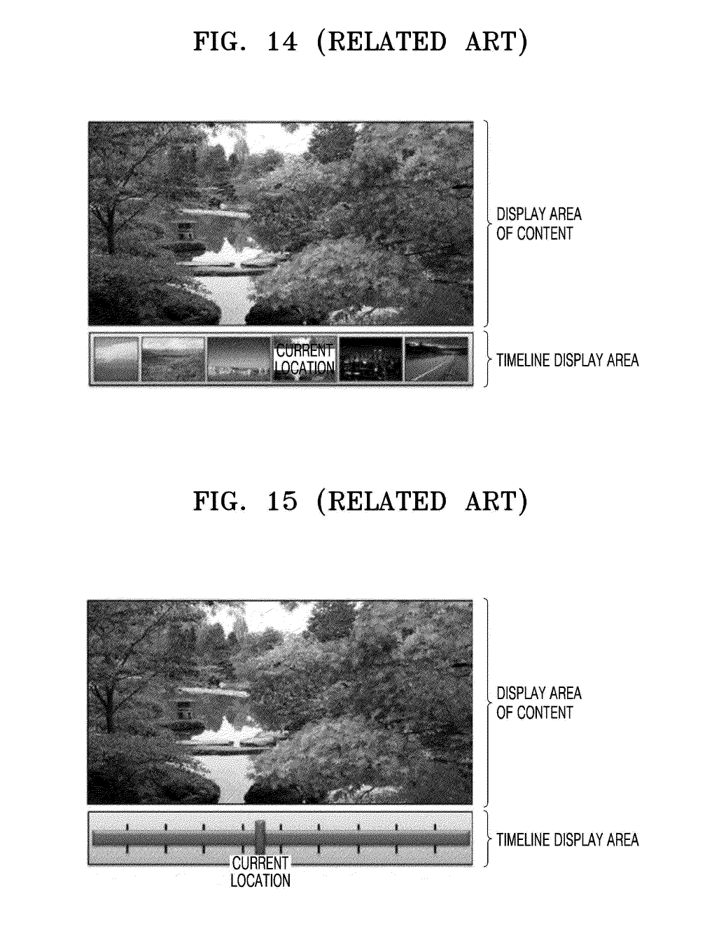

FIGS. 6 and 7 are exemplary views of a timeline in the content reproduction apparatus 10A. Unlike display methods of the related art shown in FIGS. 14 and 15, important areas occupy larger screen areas in the content reproduction apparatus 10A, thereby increasing their visibility in the timeline. Also, the user may understand the respective importance values of the areas according to different display area sizes.

When watching content on TV or a mobile device, the user may perform skip operations by pressing a button included in the TV or the mobile device. Moving operations performed by using buttons are mostly realized by a step movement function that allows the user to skip content at uniform intervals according to the number of times the buttons are pressed.

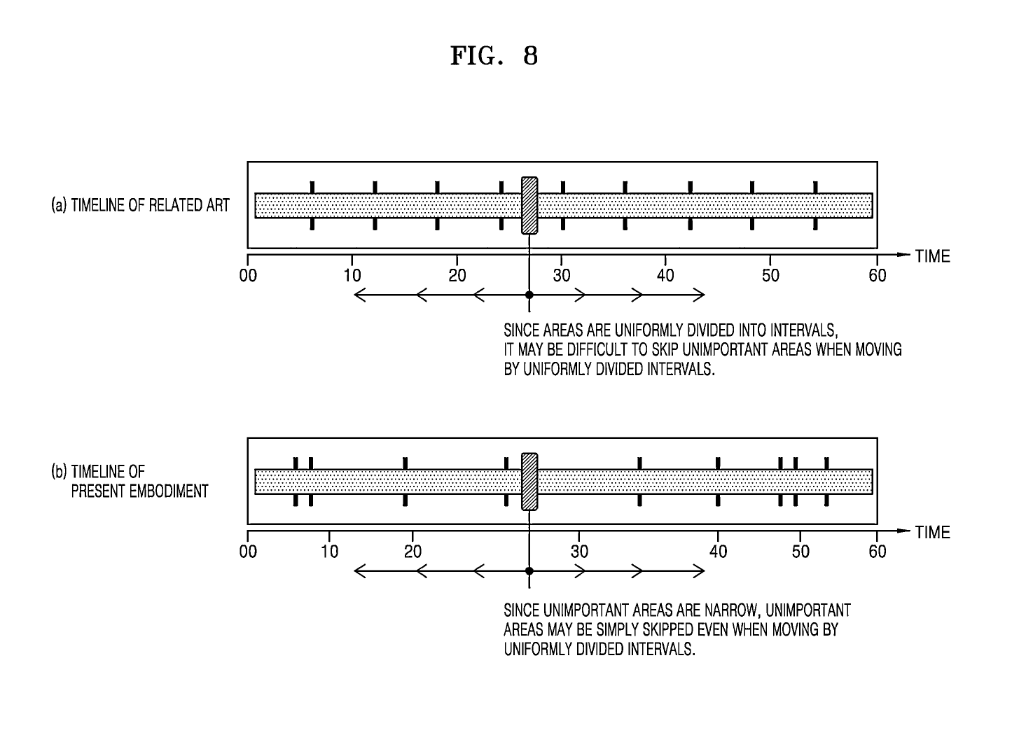

FIG. 8 is a view comparing a conventional timeline and operations of moving the conventional timeline with a timeline and operations of moving the timeline according to an exemplary embodiment. In the timeline of the related art shown in (a) of FIG. 8, because the user needs to press a button many times to skip unimportant areas, it is inconvenient for the user to move along the timeline having uniformly divided intervals. However, in the timeline of the content reproduction apparatus 10A shown in (b) of FIG. 8, unimportant areas are narrow and important areas are wide, and thus, even when the timeline has uniformly divided intervals, the user may perform a large skip operation for the unimportant areas and a small skip operation for the important areas. Accordingly, the unimportant areas may be easily skipped.

Hereinafter, a method of automatically determining importance values of a next episode of a current program from a viewing result of the current program will be described.

Programs such as dramas or news may be broadcasted continuously without a great change in the program format. A “same type program” may be easily determined based on titles, broadcast time, etc. of programs. If a same type program is determined based on similarities between watching tendencies of the user, importance values obtained from a viewing result of a watched program may be applied to a non-watched program of the same type. Therefore, the user may use viewing history of the watched program so as to start watching the non-watched program of the same type by using a timeline divided according to respective importance values of areas of the watched program.

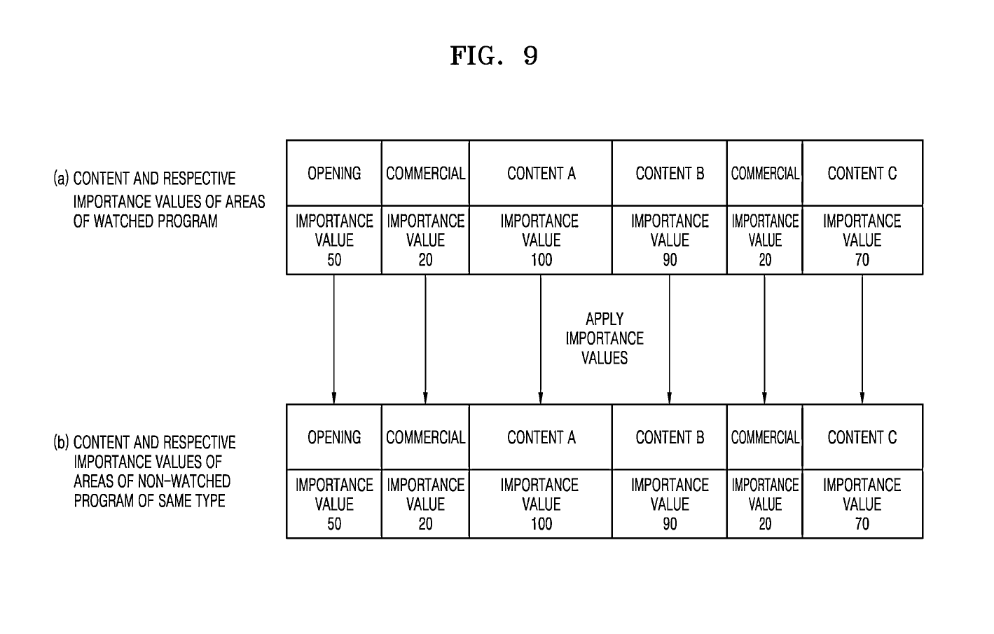

FIG. 9 is an exemplary view in which the respective importance values of the areas of the watched program are applied to the non-watched program of the same type; (a) of FIG. 9 shows the viewing result of the watched program and the respective importance values of the areas that are estimated according to the viewing result. When the watched program and the non-watched program of the same type have identical content, the respective importance values of the areas of the watched program may be applied to areas of the non-watched program of the same type. Therefore, even when the non-watched program of the same type does not have evident manipulation history, importance values may be easily estimated for each area.

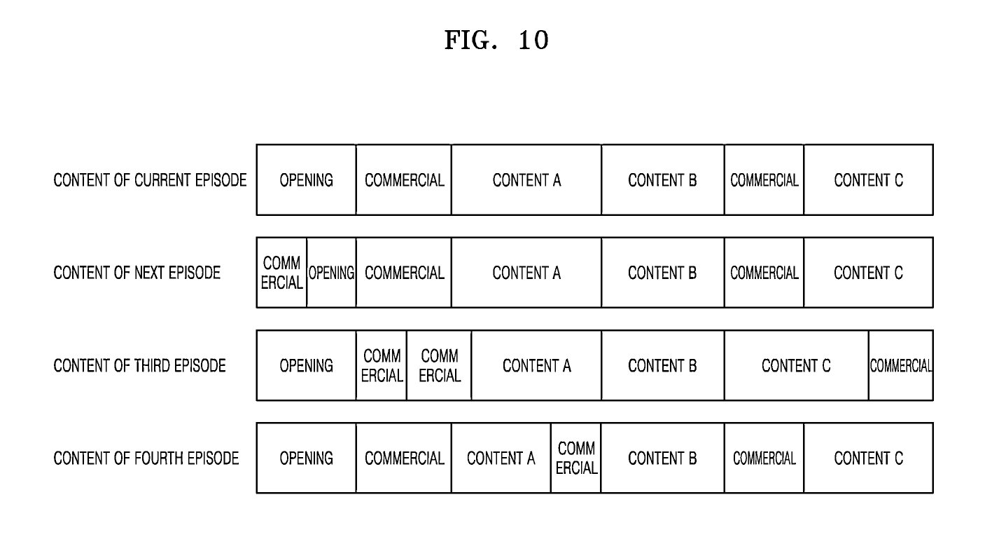

However, the same type program may not always have exactly the same content in every episode. FIG. 10 is a view for comparing episodes of a same type program which have slightly different content. Although each episode of the same type program may have slightly different content, as shown in FIG. 10, because the difference is not significant, a pattern matching method may be used to estimate corresponding areas.

A dynamic programming (DP) matching method may be used for string matching. The DP matching method may be used by forming a matrix including matching original strings in rows and matching destination strings in columns. A couple of penalty conditions need to be determined in the DP matching method. One penalty condition is related to letter movement, and the other is related to letter correspondence. In TV or radio content, tags, which indicate boundaries of areas of the content, are defined as words (e.g., “opening” or “commercial”). Therefore, the DP matching method may be performed by considering each tag as a letter.

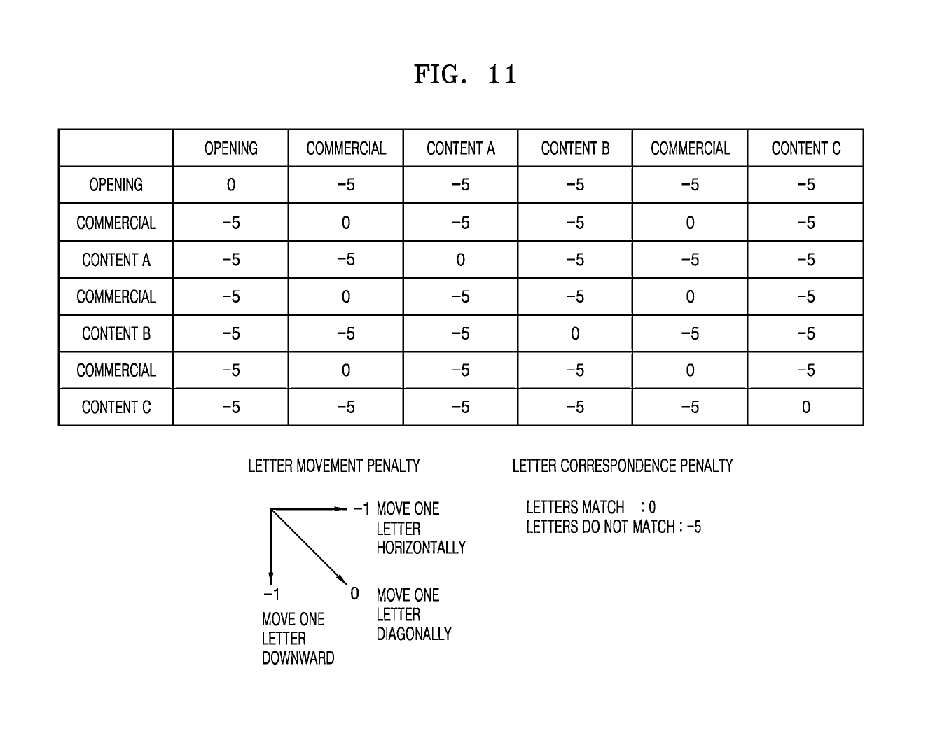

FIG. 11 is a view of a score matrix of “letter correspondence penalties” between two same type programs. Rows of the score matrix of FIG. 11 are word strings (reference word strings) that indicate content of the watched program, i.e., matching sources, which correspond to, for example, “content of a current episode” of FIG. 10. Columns of the score matrix of FIG. 11 are word strings (matching word strings), i.e., matching destinations, which correspond to “content of a fourth episode” of FIG. 10.

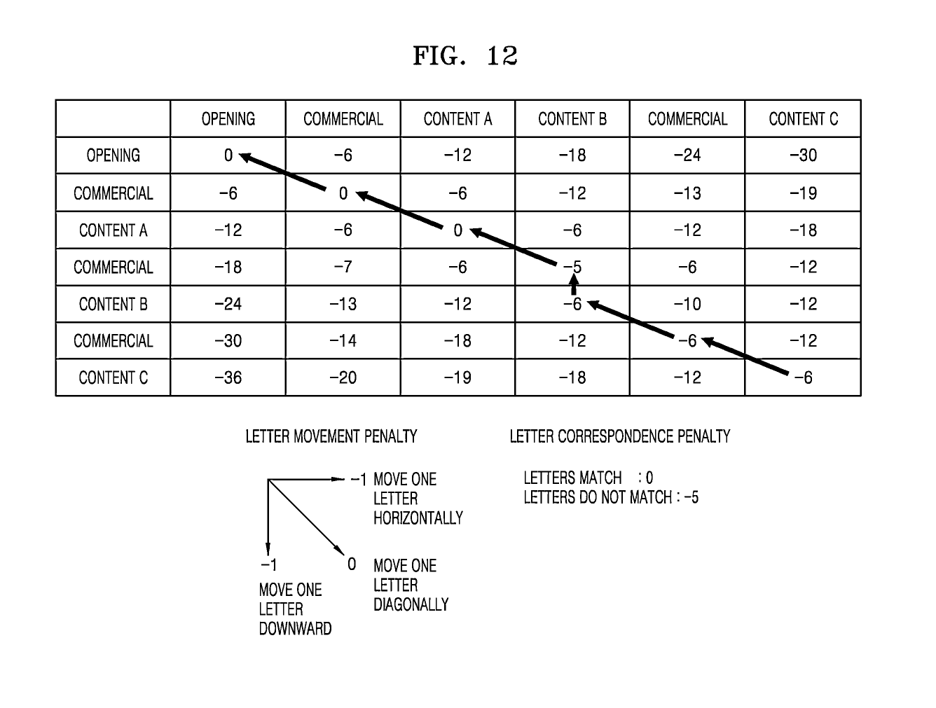

Movement costs to minimize the penalties may be integrated from the upper left end of the score matrix of FIG. 11. Accordingly, a score matrix of letter movement penalties between the two programs of the same type may be obtained as in FIG. 12. Therefore, a word string matching result is a movement path in which the movement cost is the minimum.

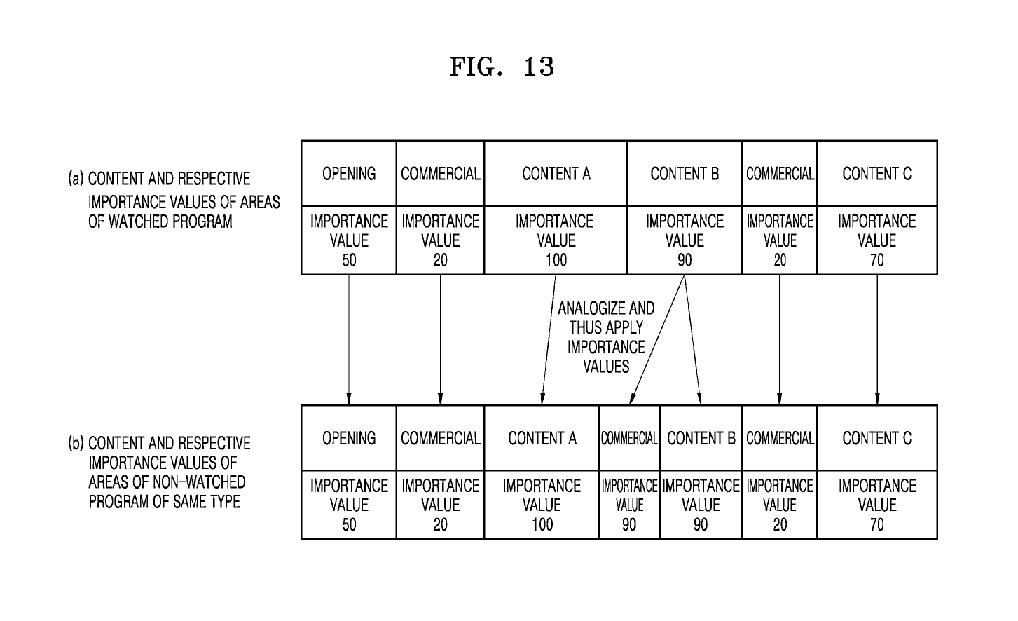

FIG. 13 is an exemplary view illustrating analogizing and thus applying the respective importance values of the areas of the watched program to the non-watched program of the same type. Based on a matching result shown in FIG. 12, the areas of the watched program in (a) of FIG. 13 may be matched with the areas of the non-watched program of the same type in (b) of FIG. 13. As illustrated in FIG. 13, areas may be matched by using the DP matching method considering a case where the areas of (a) of FIG. 13 and the areas of (b) of FIG. 13 do not correspond to each other so that there may be no errors even when importance values of the watched program are applied to a non-watched program.

Respective importance values of areas of a program may be determined based on not only respective manipulation histories, but also respective time lengths of the areas. For example, a commercial and an opening, which are short time areas, may have low importance. Therefore, the timeline estimator 18 may estimate the respective importance values of the areas of the program such that a longer time area has higher importance value. Thus, the respective importance values of the areas of the program may be easily estimated.

Alternatively, the respective importance values of the areas of the program may be determined based on motions of the areas. For example, an area in which an image does not move, i.e., an area that has almost no motion, may have a small importance value, and respective time axes of the areas on a timeline may be reduced. Therefore, the timeline estimator 18 may estimate the respective importance values of the areas of the program such that importance values are greater in areas that have great amount of motions. Respective motion amounts of the areas may be determined based on respective codec compression rates of the areas or spatial frequency of an image. An area has a small motion amount when a codec compression rate of the area is high, or when the spatial frequency of the image includes less high frequency elements. Therefore, the respective importance values of the areas of the program may be easily estimated.

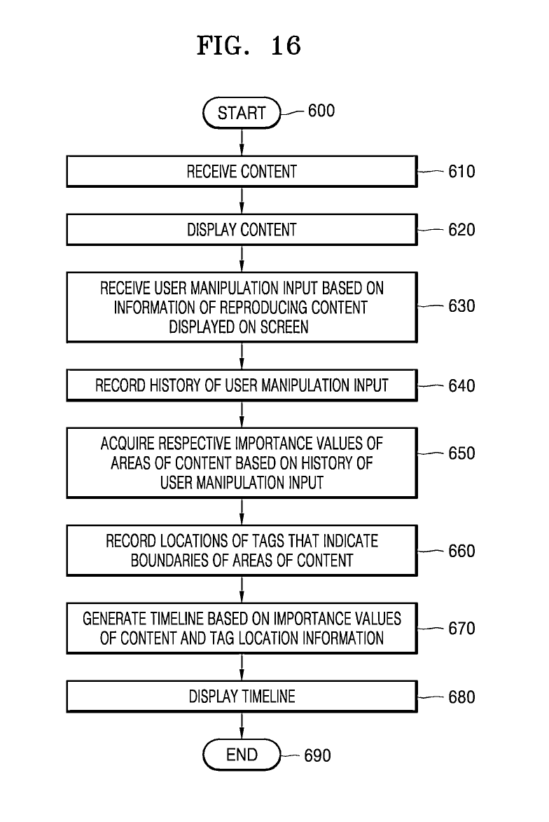

FIG. 16 is a flowchart of a content reproduction method according to an exemplary embodiment.

The method starts in operation 600.

In operation 610, a content reproduction apparatus receives TV or radio content transmitted from a content distribution company.

In operation 620, the content reproduction apparatus displays the received content on a screen.

In operation 630, the content reproduction apparatus receives a manipulation input from the user, based on information of reproducing the content displayed on the screen.

In operation 640, the content reproduction apparatus records history of the manipulation input.

In operation 650, the content reproduction apparatus acquires respective importance values of areas of the content based on history of the manipulation input that is recorded with respect to each area of the content.

In operation 660, the content reproduction apparatus records locations of tags on time axes. The tags indicate boundaries of the areas (e.g., chapters or scenes) of the received content.

In operation 670, the content reproduction apparatus generates a timeline that shows the time axes of the content, based on the respective importance values of the areas of the content and tag location information.

In operation 680, the content reproduction apparatus displays the estimated timeline.

The method ends in operation 690.

As described above, according to the present exemplary embodiment, importance values of content may be added to a timeline, which has been used for visualizing reproduction location in the related art. The importance values of the content may be visually identified by dynamically changing display areas of the timeline based on the importance values of the content. Also, moving operations are performed at uniformly divided intervals on the timeline according to the present exemplary embodiment in consideration of the importance values. Thus, the moving operations nearly correspond to user manipulations. In other words, a user may perform a large skip operation for a location that has a low importance value and a small skip operation for a location having a high importance value. Also, the timeline may be used for non-watched programs of the same type. According to the present exemplary embodiment, corresponding locations may be matched by using the DP matching method considering differences between same type programs, and thus, it is possible to apply a viewing result of the watched program to the non-watched programs of the same type.

As described above, according to the one or more of the above exemplary embodiments, a content reproduction apparatus displays a timeline whereby the user may easily understand and manipulate content easily on a limited screen display area. Therefore, the user may watch the content more conveniently.

In addition, other exemplary embodiments can also be implemented through computer readable code/instructions in/on a medium, e.g., a computer readable medium, to control at least one processing element to implement any above described exemplary embodiment. The medium can correspond to any medium/media permitting the storage and/or transmission of the computer readable code.

The computer readable code can be recorded/transferred on a medium in a variety of ways, with examples of the medium including recording media, such as magnetic storage media (e.g., ROM, floppy disks, hard disks, etc.) and optical recording media (e.g., CD-ROMs, or DVDs), and transmission media such as Internet transmission media. Thus, the medium may be such a defined and measurable structure including or carrying a signal or information, such as a device carrying a bitstream according to one or more exemplary embodiments. The media may also be a distributed network, so that the computer readable code is stored/transferred and executed in a distributed fashion. Furthermore, the processing element could include a processor or a computer processor, and processing elements may be distributed and/or included in a single device.

It should be understood that the exemplary embodiments described therein should be considered in a descriptive sense only and not for purposes of limitation. Descriptions of features or aspects within each exemplary embodiment should typically be considered as available for other similar features or aspects in other exemplary embodiments.

While one or more exemplary embodiments have been described with reference to the figures, it will be understood by those of ordinary skill in the art that various changes in form and details may be made therein without departing from the spirit and scope as defined by the following claims.

What is claimed is:

1. A method of reproducing content, the method comprising:
receiving a manipulation input from a user that provides information relating to reproducing content displayed on a screen;
receiving an importance value of the content based on history of the manipulation input;
recording location information of tags on a time axis, wherein the tags indicate boundaries within the content;
generating a timeline based on the importance value of the content and the location information of the tags; and
displaying the timeline.

2. The method of claim 1, wherein the generating of the timeline further comprises:
estimating respective importance values of areas of the content based on the history of the manipulation input that is received with respect to each area of the content.

3. The method of claim 1, wherein the generating of the timeline further comprises:
expanding and reducing the time axis of the timeline based on respective importance values of areas of the content and the location information of the tags.

4. The method of claim 2, wherein the generating of the timeline further comprises:
using respective importance values of areas of same type content received in the past as the respective importance values of the areas of the content.

5. The method of claim 1, wherein the generating of the timeline further comprises:
estimating respective importance values of areas of the content such that a longer time area has a higher importance value.

6. The method of claim 1, wherein the respective locations of the tags on the time axis are boundaries of areas of the content, the areas being chapters or scenes.

7. The method of claim 1, wherein the generating of the timeline further comprises:
estimating respective importance values of areas of the content such that an area that has a greater amount of motion has a higher importance value.

8. An apparatus for reproducing content, the apparatus comprising:
a content receiver configured to receive content;
a content display configured to display the content;
a tag location recorder configured to record respective locations of tags on time axes, wherein the tags indicate boundaries of area of the content;
a timeline estimator configured to estimate a timeline that shows time axes of the content and expand and reduce the time axes of the timeline for each area of the content based on respective importance values of the areas of the content and the location information of the tags recorded in the tag location recorder; and
a timeline display configured to display the timeline.

9. The apparatus of claim 8, further comprising:
a content manipulator configured to acquire a manipulation input from a user, based on information related to reproducing the content displayed on the content display; and
a content manipulation history recorder configured to record history of the manipulation input,
wherein the timeline estimator is further configured to estimate the respective importance values of the areas of the content based on history of the manipulation input that is recorded in the content manipulation history recorder with respect to each area of the content.

10. The apparatus of claim 9, wherein the timeline estimator is further configured to use respective importance values of areas of same type content received in the past as the respective importance values of the areas of the content.

11. The apparatus of claim 8, wherein the timeline estimator is further configured to estimate the respective importance values of the areas of the content such that a longer time area has a higher importance value.

12. The apparatus of claim 8, wherein the timeline estimator is further configured to estimate the respective importance values of the areas of the content such that an area that has a greater amount of motion has a higher importance value.

13. A non-transitory computer-readable recording medium having recorded thereon a program, which, when executed by a computer, performs the method of claim 1.

14. A method of adjusting a timeline for content reproduction, the method comprising:
receiving, using a content receiver, content and tag locations within the content that partition the content into areas;
generating importance values that correspond to the areas;
adjusting width values of the areas on a time axis of the timeline based on corresponding importance values;
displaying, on a display, the adjusted areas along the time axis of the timeline.

15. The method of claim 14, wherein the adjusting the width values further comprises:
compressing the areas based on the importance values; and
normalizing the compressed areas to fit the time axis.

16. The method of claim 14, wherein the generating the importance values further comprises:
determining the importance values as empirical values based on statistical data of evaluation values regarding the timeline,
wherein the evaluation values are obtained from a plurality of subjects, and
wherein the plurality of subjects include at least one from among a number of manipulations, a type of manipulation, a length of an area, a previous similar area manipulation, and a previous similar area adjustment.

17. The method of claim 14, wherein the generating the importance values further comprises:
generating the importance values based on predetermined values that each correspond to a specific area of the content.
